(19) United States
(12) Patent Application Publication
(10) Pub. No.: US 2025/0057364 A1
(43) Pub. Date: Feb. 20, 2025

(54) SMART CONTAINER DEVICE AND SYSTEM

(71) Applicant: Yaron Levite, Hadera (IL)

(72) Inventor: Yaron Levite, Hadera (IL)

(21) Appl. No.: 18/794,079

(22) Filed: Aug. 5, 2024

Related U.S. Application Data
(60) Provisional application No. 63/519,908, filed on Aug. 16, 2023.

(51) Int. Cl. A47J 47/10; G06V 20/68; H04N 23/57

(52) U.S. Cl. CPC A47J 47/10; G06V 20/68; H04N 23/57

(57) ABSTRACT

A smart container system and device may include a base and a sidewall which may be coupled together in the shape of a container to form a container cavity that may contain a desired volume of a food item. The device may include a camera that may be coupled to the sidewall and that may be configured to record image data of food items contained in the container cavity. An optional processing unit may be in electronic communication with the camera. Optionally, the device may include a network interface which may enable the device to communicate image data to one or more client devices of a smart container system, the image data optionally processed and analyzed by one or more servers, so that the image data and other data describing the status of food items contained in the container cavity may be generated by the device.

### CROSS REFERENCE TO RELATED APPLICATIONS

This application claims priority to and the benefit of the filing date of U.S. Provisional Application No. 63/519,908, filed on Aug. 16, 2023, entitled “SMART CONTAINER DEVICE”, which is hereby incorporated by reference in its entirety.

### FIELD OF THE INVENTION

This patent specification relates to the field of food preparation devices and systems. More specifically, this patent specification relates to a food preparation device that is configured to hold food items and to provide data describing the food items held by the device and a system of using the same.

### BACKGROUND

Cooking, baking, and other culinary disciplines are enjoyed by people throughout the world. Unfortunately, some of the best food recipes require the most time and attention. As an example, this is especially important for bread making, in which it is important to measure dough volume changes. For this reason, many people are unable to attempt or successfully prepare time intensive recipes.

Therefore a need exists for novel food preparation devices and systems. There is also a need for novel food preparation devices and systems that are able to assist users with difficult and time intensive food recipes. A further need exists, for novel food preparation devices and systems which are able to hold or contain food items and to provide data describing the contained food items.

### BRIEF SUMMARY OF THE INVENTION

A smart container device is provided that may be configured to hold or contain food items and to generate image data of the food items which may be used to provide change data describing the food items, such as changes in the size, shape, color, texture and appearance, etc. In some embodiments, the device may include a sidewall coupled to the base, the sidewall extending away from the base. A container cavity may be formed by an interior surface, the interior surface coupled to the base and sidewall, and the container cavity may be configured to contain a desired volume of a food item. A camera may be coupled to the sidewall, and the camera may be configured to record image data of the interior surface and of the food item contained in the container cavity.

A smart container system is provided which may be used to provide data describing food items held by a smart container device to the client device of a user. The data describing the food items may include image data of the food items and change data describing the food items, such as changes in the size, shape, color, texture and appearance, etc. In some embodiments, the system may include a smart container device and a client device. The smart container device may include a sidewall coupled to the base, the sidewall extending away from the base. A container cavity may be formed by an interior surface, the interior surface coupled to the base and sidewall, and the container cavity may be configured to contain a desired volume of a food item. A camera may be coupled to the sidewall, and the camera may be configured to record image data of the container cavity. A processing unit may be in electronic communication with the camera, and the processing unit may comprise a network interface. The client device may be in electronic communication with the network interface of the smart container device to enable the client device to receive image data that has been recorded by the camera.

### BRIEF DESCRIPTION OF THE DRAWINGS

Some embodiments of the present invention are illustrated as an example and are not limited by the figures of the accompanying drawings, in which like references may indicate similar elements and in which:

FIG. 1-FIG. 1 shows a perspective view of an example of a smart container device according to various embodiments described herein.

FIG. 2-FIG. 2 illustrates a block diagram illustrating an example of a smart container device according to various embodiments described herein.

FIG. 3A-FIG. 3A depicts a first sectional, through line 3-3 shown in FIG. 1, elevation view of an example of a smart container device having a food item that is occupying a relatively smaller volume of its container cavity according to various embodiments described herein.

FIG. 3B-FIG. 3B shows a second sectional, through line 3-3 shown in FIG. 1, elevation view of an example of a smart container device having a food item that is occupying a relatively larger volume of its container cavity according to various embodiments described herein.

FIG. 4-FIG. 4 illustrates some computer implemented methods and computing devices of a smart container system according to various embodiments described herein.

FIG. 5-FIG. 5 depicts a block diagram showing an example of a server which may communicate with a smart container device according to various embodiments described herein.

FIG. 6-FIG. 6 shows a block diagram illustrating an example of a client device which may communicate with a smart container device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

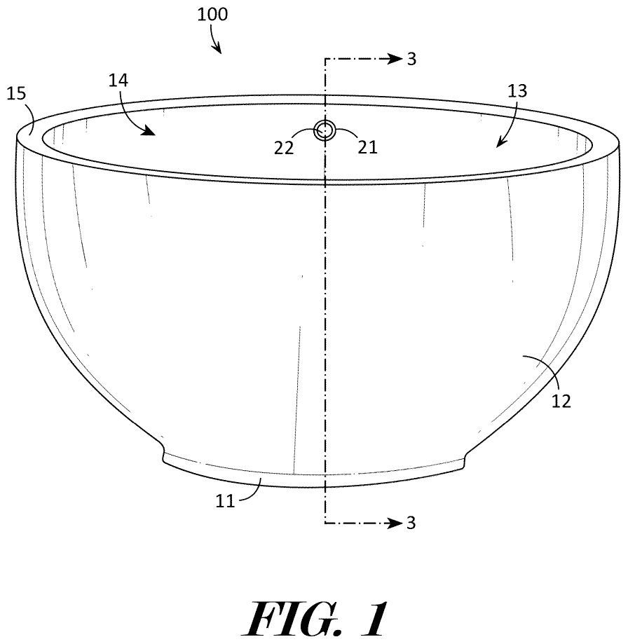

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 15% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer based on instructions received by computer software.

The term “client device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of client devices which are portable and easily carried by a person from one location to another may sometimes be referred to as a “portable client device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigby network, or a voice-over-IP (VOIP) network.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new smart container device and system are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1-4 show examples of a smart container device (“the device”) 100 according to various embodiments described herein. In some embodiments, the device 100 may comprise a base 11 and a sidewall 12 which may be coupled together in the shape of a bowl or other size or shape of container to form a container cavity 13 that may contain a desired volume of a food item. The device 100 may include a camera 21 that may be coupled to the sidewall 12 and that may be configured to record image data of food items 200 contained in the container cavity 13. An optional processing unit 90 may be in electronic communication with the camera 21. The device 100 may optionally include a network interface 93 which may enable the device 100 to communicate image data, such as to one or more client devices 400 so that the image data and other data may be viewable by a user 102 of the one or more client devices 400.

The device 100 may be configured as a food holding container of any shape and size. In preferred embodiments, the device 100 may be configured generally as a bowl having a base 11, a sidewall 12, a container cavity 13, and a rim 15. The sidewall 12 may be coupled to the base 11 so that the sidewall 12 is extending above or away from the base 11. As an example, the sidewall 12 may be between 10 and 12 inches in diameter with a container cavity 13 having a depth of between 3 and 7 inches.

The container cavity 13 may be formed by an interior surface 14, and the interior surface 14 may be coupled to the base 11 and sidewall 12. The interior surface 14 may be made from of comprise a food safe material, such as stainless steel, ceramic, food-grade nylon, polyurethane, vinyl, Bisphenol A free polycarbonate (BPA-free polycarbonate), High-density polyethylene (HDPE), other types of polyethylene, polyvinyl chloride, rubber, silicone, copper, aluminum, nickel, Pyrex glass, or any other suitable food-grade material.

The device 100 may include a camera 21, having a camera lens 22, that may be coupled to the sidewall 12 and that may be configured to record image data, such as still image data and/or video image data, of the container cavity 13, the interior surface 14, and any food items 200 contained in the container cavity 13. In preferred embodiments, a camera 21 may comprise a digital camera that encodes images and videos digitally on a charge-coupled device (CCD) image sensor or on a complementary metal-oxide-semiconductor (CMOS) image sensor and stores them for later reproduction. In other embodiments, a camera 21 may comprise any type of camera which includes an optical system, typically using a lens with a variable diaphragm to focus light or other electromagnetic radiation, such as infrared radiation for thermal imaging, onto an image pickup device or image sensor.

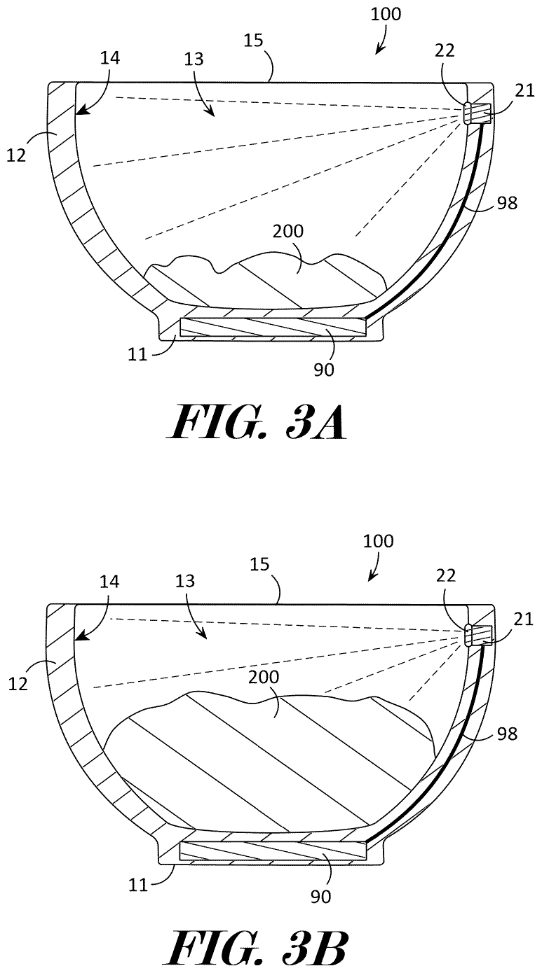

A camera 21 may be coupled to any element of the device 100. In preferred embodiments, a camera 21 may be coupled to the sidewall 12 so that the camera lens 22 may be coupled to the interior surface 14 proximate (within 5.0 inches and more preferably within 3.0 inches) to the rim 15. The camera lens 22 may be positioned and/or orientated so that the camera 21 may capture or record image data of the container cavity 13, the interior surface 14, and any food items 200 that are in the container cavity 13. In preferred embodiments, and as perhaps best shown in FIGS. 3A and 3B, the camera lens 22 may be positioned and/or orientated so that the camera 21 may capture or record image data that describes changes in size, texture and appearance, color and shape of food items 200 that are in the container cavity 13, such as changes in the size and shape of bread dough as it rises. In further preferred embodiments, and as perhaps best shown in FIGS. 3A and 3B, the camera lens 22 may be positioned and/or orientated so that the camera 21 may capture or record image data that describes changes in the amount of interior surface 14 visible to the camera lens 22, such as decreases in the amount of interior surface 14 visible as the size and shape of food items 200 that are in the container cavity 13 increase, e.g., bread dough as it rises, yogurt as it ferments, etc. Video and image data recorded by the camera 21 may include: the amount or changes in the amount of the interior surface 14 visible in recorded video and image data; the amount or changes in the amount of food items 200 in the container cavity 13 visible in recorded video and image data; the ratio or changes in the ratio of food items 200 to interior surface 14 visible in recorded video and image data; etc.

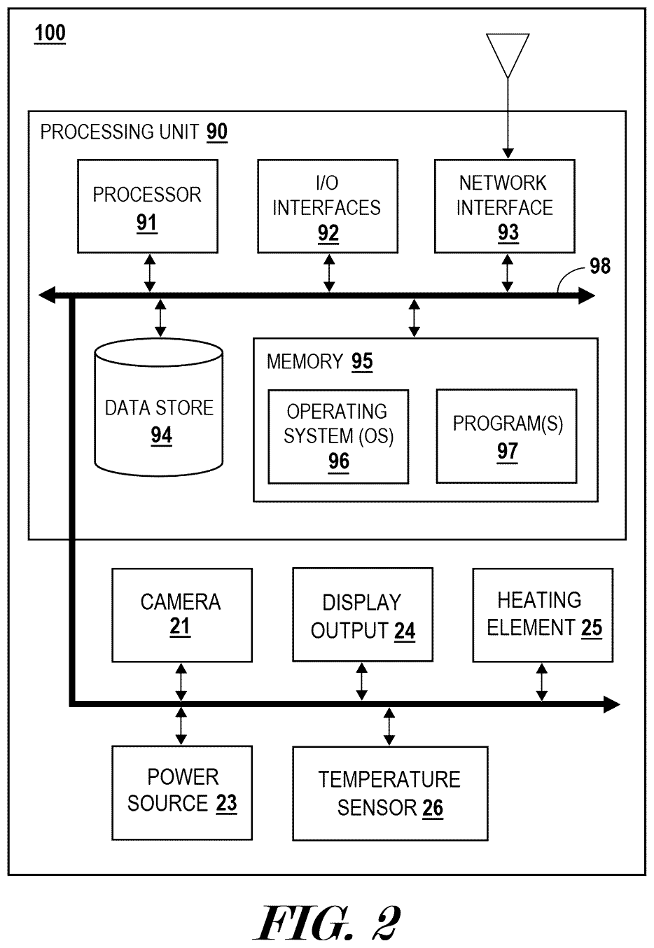

Optionally, and as shown in FIG. 2, the device 100 may comprise or may be in communication with a power source 23 which may provide electrical power to any component that may require electrical power. In some embodiments, a power source 23 may comprise a battery, such as a lithium ion battery, nickel cadmium battery, alkaline battery, or any other suitable type of battery, a fuel cell, a capacitor, a super capacitor, or any other type of electricity storing and/or releasing device. In further embodiments, a power source 23 may comprise a power cord, kinetic or piezo electric battery charging device, a solar cell or photovoltaic cell, and/or inductive charging or wireless power receiver. In further embodiments, a power source 23 may comprise a power charging and distribution module which may be configured to control the recharging of the power source 23, discharging of the power source 23, and/or distribution of power to one or more components of the device 100 that may require electrical power.

In some embodiments, the device 100 may comprise a display output 24 which may be configured to visually apprise a user 102 of the status of one or more elements of the device 100 and/or of one or more conditions that the device 100 is in. For example, if all elements of the device 100 are working properly, a light emitting type of display output 24, such as a LED light, may be operated by the processing unit to emit green light. As another example, a display output 24 may be configured to visually apprise a user 102 of the status or charge level of a secondary power source 23. To provide visual information to a user 102, embodiments of a display output 24 can be implemented with one or more light emitting elements or other display devices, e.g., a LED (light emitting diode) display or LCD (liquid crystal display) monitor, for displaying information.

In some embodiments, the device 100 may comprise one or more heating elements 25 which may be coupled to a base 11 and/or sidewall 12 and which may be configured to provide heat to the all or portions of the interior surface 14 thereby raising or controlling the temperature of all or portions of the container cavity 13. In some embodiments, a heating element 25 may comprise a device that converts electricity into heat through the process of resistive or Joule heating. Electric current passing through the heating element 25 encounters resistance, resulting in heating of the element 25. An electric heating element 25 may comprise one or more Peltier chips, metal heating elements, such as nichrome, Kanthal (FeCrAl), and the like, ceramic heating elements, such as molybdenum disilicide (MoSi2), polymer heating elements, such as PTC rubber, composite heating elements, such as fine coil of nichrome (NiCr) resistance heating alloy wire, that is located in a metallic tube (of stainless steel alloys, such as Incoloy, or copper) and insulated by magnesium oxide powder, and combination heating element systems, such as those using thick film technology, or any other device that converts electricity into heat.

In some embodiments, the device 100 may comprise one or more temperature sensors 26 which may be configured to generate temperature data describing all or portions of the interior surface 14 and which, therefore, may be used to describe the temperature of portions of a food item 200 in the container cavity 13 and resting on the interior surface 14. In further embodiments, a temperature sensor 26 may be configured to provide temperature data which may be used by the processor 91 to operate one or more heating elements 25 in order to raise or maintain the temperature of all or portions of the interior surface 14 of the container cavity 13. A temperature sensor 26 may comprise a thermocouple, a resistive temperature device (RTDs, thermistors), an infrared temperature sensor, a bimetallic device, a liquid expansion device, a molecular change-of-state device, a silicon diode, or any other type of temperature sensor configured to electrically communicate temperature information. A temperature sensor may be coupled to the base 11 and/or sidewall 12.

While some materials have been provided, in other embodiments, the elements that comprise the device 100, such as the base 11, sidewall 12, interior surface 14, and/or any other element discussed herein may be made from durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

FIG. 2 depicts a block diagram of an example of a smart container device 100 according to various embodiments described herein. In some embodiments, the device 100 may be a digital device that, in terms of hardware architecture, may optionally comprise a processing unit 90 that may be in electronic communication with a camera 21. It should be appreciated by those of ordinary skill in the art that FIG. 2 depicts an example of the device 100 in an oversimplified manner, and a practical embodiment may include additional components or elements and suitably configured processing logic to support known or conventional operating features that are not described in detail herein.

The components and elements of the device 100 may be communicatively coupled via a local interface 98. The local interface 98 can be, for example but not limited to, one or more buses or other wired or wireless connections, as is known in the art. The local interface 98 can have additional elements, which are omitted for simplicity, such as controllers, buffers (caches), drivers, repeaters, and receivers, among many others, to enable communications. Further, the local interface 98 may include address, control, and/or data connections to enable appropriate communications among the aforementioned components.

In some embodiments, a processing unit 90 may comprise one or more processors 91, I/O interfaces 92, network interfaces 93, data stores 94, and/or memory 95. The processor 91 is a hardware device for executing software instructions. The processor 91 can be any custom made or commercially available processor, a central processing unit (CPU), an auxiliary processor among several processors, a semiconductor-based microprocessor (in the form of a microchip or chip set), or generally any device for executing software instructions. When in operation, the processor 91 is configured to execute software stored within the memory 95, to communicate data to and from the memory 95, and to generally control operations of the device 100 pursuant to the software instructions. In an exemplary embodiment, the processor 91 may include a mobile optimized processor such as optimized for power consumption and mobile applications.

Optionally, the device 100 may optionally include one or more I/O interfaces 92 that can be used to input and/or output information and power. In some embodiments, I/O interfaces 92 may include one or more turnable control knobs, depressible button type switches, a key pad, slide type switches, dip switches, rocker type switches, rotary dial switches, numeric input switches or any other suitable input which a user may interact with to provide input. In further embodiments, I/O interfaces 92 may include one or more light emitting elements or other display device, e.g., a LED (light emitting diodes), a digital display screen for visually displaying data, a speaker, or any other suitable device for outputting or displaying information. The I/O interfaces 92 can also include, for example, a serial port, a parallel port, a small computer system interface (SCSI), an infrared (IR) interface, a radio frequency (RF) interface, a universal serial bus (USB) interface, and the like.

The processing unit 90 may include a network interface 93 that may enable wireless communication to an external access device or network through an antenna. A network interface 93 may comprise a wireless communication receiver and optionally a wireless communication transmitter. In some embodiments, a network interface 93 may utilize one or more wireless network protocols based on the IEEE 802.11 family of standards (e.g., Wi-Fi), which are commonly used for local area networking of devices and Internet access, allowing nearby digital devices to exchange data by radio waves. Any number of suitable wireless data communication protocols, techniques, or methodologies can be supported by the network interface 93, including, without limitation: RF; IrDA (infrared); Bluetooth; ZigBee (and other variants of the IEEE 802.15 protocol); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. In preferred embodiments, the processing unit 90 may be configured to communicate image data recorded by the camera 21 of the interior surface 14 and/or of a food item 200 contained in the container cavity 13 over a network 105, via the network interface 93, to a client device 400 and/or server 300. In preferred embodiments, the processing unit 90 may be configured to communicate change data which describes a difference between a first image data recorded by the camera 21 and a second image data recorded by the camera 21 over a network 105, via the network interface 93, to a client device 400 and/or server 300. In further preferred embodiments, the processing unit 90 may be configured to communicate, wirelessly or wiredly, image data recorded by the camera 21 of the interior surface 14 and/or of a food item 200 contained in the container cavity 13 directly to a client device 400. In further preferred embodiments, the processing unit 90 may be configured to communicate, wirelessly or wiredly, change data which describes a difference between a first image data recorded by the camera 21 and a second image data recorded by the camera 21 directly to a client device 400.

A data store 94 may be used to store data. The data store 94 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 94 may incorporate electronic, magnetic, optical, and/or other types of storage media.

A memory 95 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 95 may incorporate electronic, magnetic, optical, and/or other types of storage media. Note that the memory 95 may have a distributed architecture, where various components are situated remotely from one another, but can be accessed by the processor 91. The software in memory 95 can include one or more software programs, each of which includes an ordered listing of executable instructions for implementing logical functions. In the example of FIG. 2, the software in the memory system 95 may include a suitable operating system (O/S) 96 and programs 97. An operating system 96 essentially controls the execution of input/output interface 92 functions, and provides scheduling, input-output control, file and data management, memory management, and communication control and related services. The operating system 96 may be, for example, LINUX (or another UNIX variant) and any Linux-kernel-based operating systems, Raspbian, Ubuntu, OpenELEC, RISC OS, Arch Linux ARM, OSMC (formerly Raspbmc) and the Kodi open source digital media center, Pidora (Fedora Remix), Puppy Linux, Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 97 may include various applications, add-ons, etc. configured to provide end user functionality such as to control the operation of functions of the device 100.

In some embodiments, the processing unit 90 may be configured to operate the camera 21 to capture or record image and video data that describes changes in size and shape of food items 200 that are in the container cavity 13, such as changes in the size and shape of bread dough as it rises, changes in the color, texture appearance of yogurt, and changes in the size, shape, color, texture and appearance, of any other type of food item which may be in the container cavity 13. In further embodiments, the processing unit 90 may be configured to operate the camera 21 to capture or record image and video data once per a desired time period, such as once per second, once per five seconds, once per ten seconds, once per minute, once per five minutes, once per a time period in which the time period is less than an hour, once per a time period in which the time period is less than six hours, etc.

In some embodiments, a processor 91 of the device 100 may be configured to determine a change data which describes a difference between a first image data recorded by a camera 21 of the device 100 and a second image data recorded by the camera 21 of the device 100. In some embodiments, the processor 91 may use the video and image data recorded by the camera 21 to determine change data which may include: the amount or changes in the amount of the interior surface 14 visible in recorded video and image data; the amount or changes in the amount of food items 200 in the container cavity 13 visible in recorded video and image data; the ratio or changes in the ratio of food items 200 to interior surface 14 visible in recorded video and image data; etc., which the processor 91 may use to determine volume change data of food items 200 in the container cavity 13. For example, the processor 91 may use the video and image data recorded by the camera 21 to determine the amount or the rate of bread dough rising in the container cavity 13. Preferably, the processor 91 may determine these changes by comparing a first image data recorded by the camera 21 to a second image data recorded by the camera 21 in which the first image data was recorded at a time before the second image data was recorded, so that a period of time has elapsed between the recording of the first image data and the recording of the second image data.

In some embodiments, a processor 91 may be configured to determine a change data which describes a difference between a first image data of the interior surface 14 recorded by the camera 21 and a second image data of the interior surface 14 recorded by the camera 21. For example, a processor 91 may compare a first image data of the interior surface 14 and a second image data of the interior surface 14, the first image data taken five minutes before the second image data, and determine if a change in the amount of visible interior surface 14 is different between the first image data and the second image data. If the amount of interior surface 14 (optionally compared to the amount of visible food item 200) recorded in the second image data is less than the amount of interior surface 14 recorded in the second image data, the processor 91 may determine that the food item 200 in the container cavity 13 is rising or becoming larger. Optionally, the processor 91 may determine a rate of change in the size increase of the food item 200 using the amount of change in the interior surface 14 versus the time period taken between the first image data and the second image data. Alternatively, if the amount of interior surface 14 (optionally compared to the amount of visible food item 200) recorded in the second image data is greater than the amount of interior surface 14 recorded in the second image data, the processor 91 may determine that the food item 200 in the container cavity 13 is becoming smaller. Optionally, the processor 91 may determine a rate of change in the size decrease of the food item 200 using the amount of change in the interior surface 14 versus the time period taken between the first image data and the second image data. Optionally, the processor 91 may communicate the change data to a display output 24, and the change data may be displayed on the display output 24. Optionally, the processor 91 may communicate the change data to a client device 400 and/or a server 300 via a network interface 93.

In some embodiments, a processor 91 may be configured to determine a change data which describes a difference between a first image data of a food item 200 contained in the container cavity 13 recorded by the camera 21 and a second image data of the food item 200 contained in the container cavity 13 recorded by the camera 21. For example, a processor 91 may compare a first image data of the food item 200 and a second image data of the food item 200, the first image data taken ten minutes before the second image data, and determine if a change in the visible amount or size of food item 200 has occurred between the first image data and the second image data. If the visible amount of food item 200 (optionally compared to the amount of visible interior surface 14) recorded in the second image data is larger than the visible amount of food item 200 recorded in the second image data, the processor 91 may determine that the food item 200 in the container cavity 13 is rising or becoming larger. Optionally, the processor 91 may determine a rate of change in the size increase of the food item 200 using the amount of change in the visible amount of food item 200 versus the time period taken between the first image data and the second image data. Alternatively, if the visible amount of food item 200 (optionally compared to the amount of visible interior surface 14) recorded in the second image data is less than the visible amount of food item 200 recorded in the second image data, the processor 91 may determine that the food item 200 in the container cavity 13 is becoming smaller. Optionally, the processor 91 may determine a rate of change in the size decrease of the food item 200 using the amount of change in the visible amount of food item 200 versus the time period taken between the first image data and the second image data. Optionally, the processor 91 may communicate the change data to a display output 24, and the change data may be displayed on the display output 24. Optionally, the processor 91 may communicate the change data to a client device 400 and/or a server 300 via a network interface 93.

In some embodiments, a processor 91 may be configured to determine a change data which describes a difference between a first image data of the container cavity 13 (an image of the container cavity 13 includes the interior surface 14 and any food items 200 in the container cavity 13) recorded by the camera 21 and a second image data of the container cavity 13 recorded by the camera 21. For example, a processor 91 may compare a first image data of the container cavity 13 and a second image data of the container cavity 13, the first image data taken fifteen minutes before the second image data, and determine if a change in the amount of visible interior surface 14 and/or visible food items 200 is different between the first image data and the second image data. If the amount of interior surface 14 (optionally compared to the amount of visible food item 200) recorded in the second image data is less than the amount of interior surface 14 recorded in the second image data and/or the amount of visible amount of food item 200 (optionally compared to the amount of visible interior surface 14) recorded in the second image data is larger than the visible amount of food item 200 recorded in the second image data, the processor 91 may determine that the food item 200 in the container cavity 13 is rising or becoming larger. Optionally, the processor 91 may determine a rate of change in the size increase of the food item 200 using the amount of change of the visible interior surface 14 and/or food items 200 versus the time period taken between the first image data and the second image data. Alternatively, if the amount of interior surface 14 (optionally compared to the amount of visible food item 200) recorded in the second image data is greater than the amount of interior surface 14 recorded in the second image data and/or the amount of visible amount of food item 200 (optionally compared to the amount of visible interior surface 14) recorded in the second image data is larger than the visible amount of food item 200 recorded in the second image data, the processor 91 may determine that the food item 200 in the container cavity 13 is becoming smaller. Optionally, the processor 91 may determine a rate of change in the size decrease of the food item 200 using the amount of change in the interior surface 14 versus the time period taken between the first image data and the second image data. Optionally, the processor 91 may communicate the change data to a display output 24, and the change data may be displayed on the display output 24. Optionally, the processor 91 may communicate the change data to a client device 400 and/or a server 300 via a network interface 93.

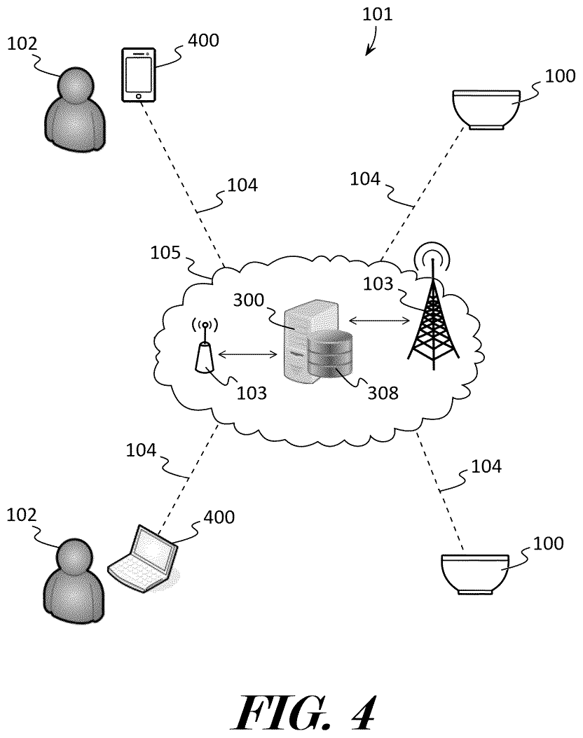

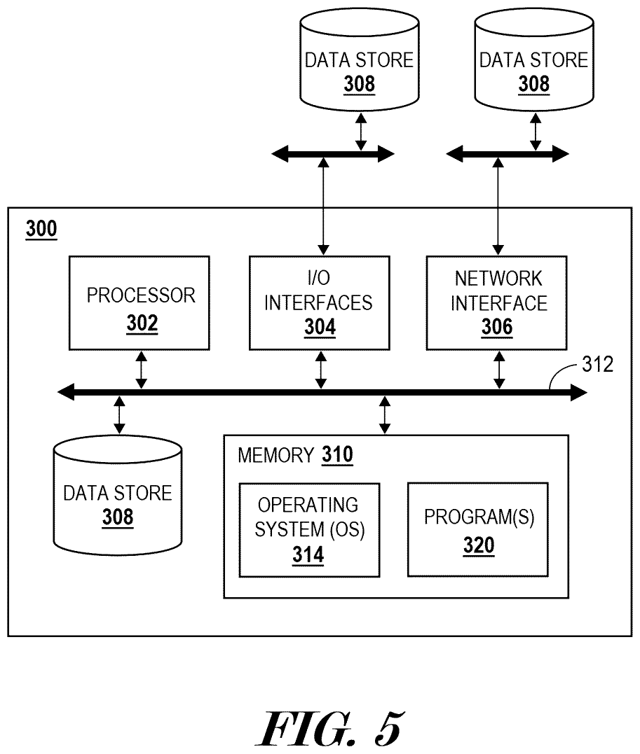

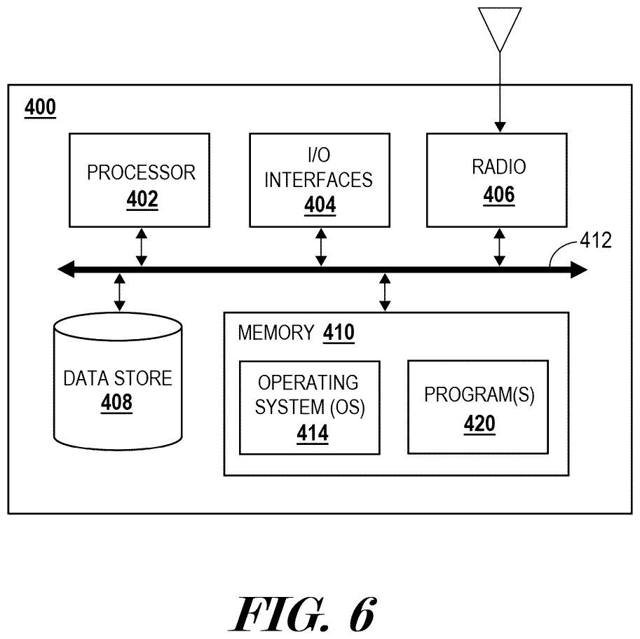

Referring now to FIG. 4, a smart container system (“the system”) 101 and illustrative examples of some of the physical components which may comprise the system 101 according to various embodiments is presented. The system 101 may be configured to facilitate the transfer of data and information between one or more access points 103, smart container devices 100, client devices 400, and servers 300 over a data network 105. Client devices 400 and servers 300 may send data to and receive data from the data network 105 through a network connection 104 with an access point 103. Optionally, one or more smart container devices 100 may send data to and receive data from a client device 400 through a network connection 104 with the client device 400. Optionally, one or more smart container devices 100 may send data to and receive data from a client device 400 and/or a server 300 from the data network 105 through a network connection 104 with an access point 103. The data may include image data recorded by a camera 21 of a device 100, such as image data of the container cavity 13 of the device 100, image data of a food item 200 in the container cavity 13 of the device 100, image data of the interior surface 14 of the device 100, etc., and change data which describes a difference between a first image data recorded by the camera 21 of the device 100 and a second image data recorded by the camera 21 of the device 100. Optionally, change data may be generated by one or more devices 100, client devices 400, and/or severs 300.

In this example, the system 101 comprises at least one client device 400 (but preferably more than two client devices 400) configured to be operated by one or more users 102. Client devices 400 may include mobile devices, such as laptops, tablet computers, personal digital assistants, smart phones, and the like, that are equipped with a wireless network interface capable of sending data to one or more servers 300 with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one computing device, such as a client device 400 and/or server 300, programmed to perform one or more of the steps described herein. In some embodiments, more than one client device 400 and/or server 300 may be used, with each being programmed to carry out one or more steps of a method or process described herein.

Preferably, the system 101 may be configured to facilitate the communication of information to and from one or more users 102, through their respective client devices 400, and servers 300 of the system 101. In some embodiments, a processing unit 90 of a device 100 may enable the device 100 to communicate data to and from one or more access points 103, servers 300 and client devices 400 via a network connection 104 enabled by the network interface 93. In preferred embodiments, a device 100 may be configured to communicate data to and from a client device 400 that may be operated by a user 102 of the device 100. Client devices 400 may include mobile devices, such as laptops, tablet computers, personal digital assistants, smart phones, and the like, that are equipped with a wireless network interface capable of sending data to one or more servers 300 with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300 with access to one or more data stores 308 over a wireless or wired local area network 105.

In some embodiments of the system 101, the processing unit 90 of a device 100 may be configured to determine a change data which describes a difference between a first image data recorded by a camera 21 of the device 100 and a second image data recorded by the camera 21 of the device 100 as discussed above. In preferred embodiments of the system 101, the processor 302 of a server 300 may be configured to determine a change data which describes a difference between a first image data recorded by a camera 21 of a device 100 and a second image data recorded by the camera 21 of the device 100. In some embodiments, the processor 302 of a server 300 may use the video and image data recorded by a camera 21 of a device 100 to determine change data which may include: the amount or changes in the amount of the interior surface 14 visible in recorded video and image data; the amount or changes in the amount of food items 200 in the container cavity 13 visible in recorded video and image data; the ratio or changes in the ratio of food items 200 to interior surface 14 visible in recorded video and image data; etc., which the processing unit 90 may use to determine volume change data of food items 200 in the container cavity 13.

In some embodiments, a server 300 may be configured to determine a change data which describes a difference between a first image data of the interior surface 14 recorded by the camera 21 of a device 100 and a second image data of the interior surface 14 recorded by the camera 21 of the device 100. For example, a processor 302 of a server 300 may compare a first image data of the interior surface 14 and a second image data of the interior surface 14, the first image data taken five minutes before the second image data, and determine if a change in the amount of visible interior surface 14 is different between the first image data and the second image data. If the amount of interior surface 14 (optionally compared to the amount of visible food item 200) recorded in the second image data is less than the amount of interior surface 14 recorded in the second image data, the processor 302 may determine that the food item 200 in the container cavity 13 is rising or becoming larger. Optionally, the processor 302 may determine a rate of change in the size increase of the food item 200 using the amount of change in the interior surface 14 versus the time period taken between the first image data and the second image data. Alternatively, if the amount of interior surface 14 (optionally compared to the amount of visible food item 200) recorded in the second image data is greater than the amount of interior surface 14 recorded in the second image data, the processor 302 may determine that the food item 200 in the container cavity 13 is becoming smaller. Optionally, the processor 302 may determine a rate of change in the size decrease of the food item 200 using the amount of change in the interior surface 14 versus the time period taken between the first image data and the second image data. Optionally, the processor 302 may communicate the change data to the device 100, and the change data may be displayed on a display output 24 of the device 100. Optionally, the processor 302 may communicate the change data to a client device 400 via a network interface 105. Optionally, the client device 400 may generate a notification, such as an audible sound, vibration, etc., via an input/output (I/O) interface 404, such as a speaker, vibrator, etc., in response to receiving the change data.

In some embodiments, a server 300 may be configured to determine a change data which describes a difference between a first image data of a food item 200 contained in the container cavity 13 recorded by the camera 21 of a device 100 and a second image data of the food item 200 contained in the container cavity 13 recorded by the camera 21 of the device 100. For example, a processor 302 of a server 300 may compare a first image data of the food item 200 and a second image data of the food item 200, the first image data taken ten minutes before the second image data, and determine if a change in the visible amount or size of food item 200 has occurred between the first image data and the second image data. If the visible amount of food item 200 (optionally compared to the amount of visible interior surface 14) recorded in the second image data is larger than the visible amount of food item 200 recorded in the second image data, the processor 302 may determine that the food item 200 in the container cavity 13 is rising or becoming larger. Optionally, the processor 302 may determine a rate of change in the size increase of the food item 200 using the amount of change in the visible amount of food item 200 versus the time period taken between the first image data and the second image data. Alternatively, if the visible amount of food item 200 (optionally compared to the amount of visible interior surface 14) recorded in the second image data is less than the visible amount of food item 200 recorded in the second image data, the processor 302 may determine that the food item 200 in the container cavity 13 is becoming smaller. Optionally, the processor 302 may determine a rate of change in the size decrease of the food item 200 using the amount of change in the visible amount of food item 200 versus the time period taken between the first image data and the second image data. Optionally, the processor 302 may communicate the change data to a display output 24 of the device 100, and the change data may be displayed on the display output 24. Optionally, the processor 302 may communicate the change data to a client device 400 via a network 105. Optionally, the client device 400 may generate a notification, such as an audible sound, vibration, etc., via an input/output (I/O) interface 404, such as a speaker, vibrator, etc., in response to receiving the change data.

In some embodiments, a server 300 may be configured to determine a change data which describes a difference between a first image data of the container cavity 13 (an image of the container cavity 13 includes the interior surface 14 and any food items 200 in the container cavity 13) recorded by the camera 21 of a device 100 and a second image data of the container cavity 13 recorded by the camera 21 of the device 100. For example, a processor 302 of a server 300 may compare a first image data of the container cavity 13 and a second image data of the container cavity 13, the first image data taken fifteen minutes before the second image data, and determine if a change in the amount of visible interior surface 14 and/or visible food items 200 is different between the first image data and the second image data. If the amount of interior surface 14 (optionally compared to the amount of visible food item 200) recorded in the second image data is less than the amount of interior surface 14 recorded in the second image data and/or the amount of visible amount of food item 200 (optionally compared to the amount of visible interior surface 14) recorded in the second image data is larger than the visible amount of food item 200 recorded in the second image data, the processor 302 may determine that the food item 200 in the container cavity 13 is rising or becoming larger. Optionally, the processor 302 may determine a rate of change in the size increase of the food item 200 using the amount of change of the visible interior surface 14 and/or food items 200 versus the time period taken between the first image data and the second image data. Alternatively, if the amount of interior surface 14 (optionally compared to the amount of visible food item 200) recorded in the second image data is greater than the amount of interior surface 14 recorded in the second image data and/or the amount of visible amount of food item 200 (optionally compared to the amount of visible interior surface 14) recorded in the second image data is larger than the visible amount of food item 200 recorded in the second image data, the processor 302 may determine that the food item 200 in the container cavity 13 is becoming smaller. Optionally, the processor 302 may determine a rate of change in the size decrease of the food item 200 using the amount of change in the interior surface 14 versus the time period taken between the first image data and the second image data. Optionally, the processor 302 may communicate the change data to a processing unit 90 of the device 100, and the change data may be displayed on a display output 24. Optionally, the processor 302 may communicate the change data to a client device 400 via a network interface 105. Optionally, the client device 400 may generate a notification, such as an audible sound, vibration, etc., via an input/output (I/O) interface 404, such as a speaker, vibrator, etc., in response to receiving the change data.

Preferably, a processing unit 90 of a device 100 may include a program 97 and/or a server 300 may include a program 320 that is configured to determine a change data which describes a difference between a first image data recorded by a camera 21 of the device 100 and a second image data recorded by the camera 21 of the device 100 which is used to determine changes in the size and shape of food items 200 within a container cavity 13. The amount of change in the size and shape of food items 200 within a container cavity 13 can be output to a user 102 via a display output 24 and/or via a display type of input/output interface 404, such as a touch display screen, of a client device 400.

The program 97, 320, can include any suitable algorithm to compute the real-time change data between two or more images or videos recorded by a camera 21. In an example where the change data refers to a change in the size/shape of a food item 200, one exemplary algorithm can include the following: receiving a first image data of a container cavity 13; analyzing the red-green-blue (RGB) color value of each pixel in the first image data associated with the food item 200; averaging all RGB color values of all food-item pixels in the first image data to compute a single first RGB color value representative of the food item 200; receiving a second image data of a container cavity 13, in which a period of time has elapsed since the first image data was recorded; analyzing the red-green-blue (RGB) color value of each pixel in the second image data associated with the food item 200; averaging all RGB color values of all food-item pixels in the second image data to compute a single second RGB color value representative of the food item 200; and comparing the first RGB color value to the second RGB color value to compute a change data that describes the difference between the first and second RGB color values. It will be understood that other processes or algorithms, including artificial intelligence that has been trained to recognize changes in size, shape, color, texture and appearance, etc. of food items 200, can be utilized to compute the change data that may describe changes in one or more food items 200 contained in a container cavity 13, such as changes in the size, shape, color, texture and appearance, etc.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A smart container device, the device comprising:
a base;
a sidewall coupled to the base, the sidewall extending away from the base;
a container cavity formed by an interior surface, the interior surface coupled to the base and sidewall, and the container cavity configured to contain a desired volume of a food item; and
a camera coupled to the sidewall, wherein the camera is configured to record image data of the interior surface and of the food item contained in the container cavity.

2. The device of claim 1, wherein the camera lens is coupled to the interior surface.

3. The device of claim 1, wherein the camera is configured to record image data of the interior surface.

4. The device of claim 1, further comprising a processing unit in electronic communication with the camera.

5. The device of claim 4, wherein the processing unit is configured to determine a change data which describes a difference between a first image data recorded by the camera and a second image data recorded by the camera.

6. The device of claim 5, further comprising a display output in communication with the processing unit, wherein the change data is displayed on the display output.

7. The device of claim 4, wherein the processing unit is configured to determine a change data which describes a difference between a first image data of the interior surface recorded by the camera and a second image data of the interior surface recorded by the camera.

8. The device of claim 4, wherein the processing unit is configured to determine a change data which describes a difference between a first image data of the food item contained in the container cavity recorded by the camera and a second image data of the food item contained in the container cavity recorded by the camera.

9. The device of claim 4, wherein the processing unit includes a network interface.

10. The device of claim 7, wherein the processing unit is configured to communicate image data of the interior surface and of the food item contained in the container cavity over a network via the network interface.

11. A smart container system, the system comprising:
a smart container device, the device having: a base; a sidewall coupled to the base and extending away from the base; a container cavity formed by an interior surface, the interior surface coupled to the base and sidewall, and the container cavity configured to contain a desired volume of a food item; a camera coupled to the sidewall, wherein the camera is configured to record image data of the container cavity, and a processing unit in electronic communication with the camera, wherein the processing unit comprises a network interface; and
a client device in electronic communication with the network interface of the smart container device.

12. The device of claim 11, wherein the camera lens is coupled to the interior surface.

13. The device of claim 11, wherein the processing unit is configured to determine a change data which describes a difference between a first image data of the container cavity recorded by the camera and a second image data of the container cavity recorded by the camera.

14. The device of claim 13, further comprising a display output in communication with the processing unit, wherein the change data is displayed on the display output.

15. The device of claim 13, wherein the processing unit is configured to communicate the change data to the client device.

16. The device of claim 11, wherein the processing unit is configured to communicate image data of the container cavity recorded by the camera to a server.

17. The device of claim 16, wherein the server is configured to determine a change data which describes a difference between a first image data of the container cavity recorded by the camera and a second image data of the container cavity recorded by the camera.

18. The device of claim 17, wherein the change data is communicated to the client device.

19. The device of claim 18, wherein the client device generates a notification in response to receiving the change data.

20. The device of claim 16, further comprising a display output in communication with the processing unit, wherein the change data is displayed on the display output.
